(19) United States
(12) Patent Application Publication
(10) Pub. No.: US 2017/0274613 A1
(43) Pub. Date: Sep. 28, 2017

(54) BOTTOM FOLD BAG AND METHOD OF MAKING SAME

(71) Applicant: SPG Holdings LLC, Atlanta, GA (US)

(72) Inventor: Thomas I. Stafford, III, Roswell, GA (US)

(21) Appl. No.: 15/464,422

(22) Filed: Mar. 21, 2017

Related U.S. Application Data
(60) Provisional application No. 62/312,022, filed on Mar. 23, 2016.

(51) Int. Cl. B65D 30/20; B65D 30/08; B31B 29/60

(52) U.S. Cl. CPC B31B 23/00; B65D 31/04; B65D 31/10; B31B 19/26; B31B 19/62; B31B 19/64; B31B 19/68; B31B 19/16; B31B 2219/145; B31B 2219/2681; B31B 2219/6007; B31B 2219/603; B31B 2219/6084; B31B 2237/10

(57) ABSTRACT

Bags for containing various retail items, such as food items, and methods of forming the same. In some aspects, a bag having a top and bottom is provided. The bags can include a first layer and a second layer opposite the first layer and uniformly extending from the first layer. In some aspects, the bag can further include a first side seam between a side of the first layer and an opposing side of the second layer and a second side seam between a side of the second layer and an opposing side of the second layer. The first layer and the second layer each have an un-folded edge substantially parallel to the bottom fold. In some aspects, the bags include a bottom V-shaped fold extending along a transverse axis relative to the first side seam and the second side seam, the bottom V-shaped fold forming a seamless bottom.

### BACKGROUND

The present disclosure generally relates to bags and more specifically to a bag having a bottom fold.

Pinch bottom bags are commonly used in a variety of industries to hold products in retail settings. For example, the food service industry utilizes pinch bottom bags to contain food products such as cookies when packaged at a point of sale. For example, fast-food chains typically provide cookies as part of “meals” available for purchase at a cash-register. These cookies are often placed in a pinch bottom bag prior to handing the cookie to the purchaser.

Conventional pinch bottom bags, however, have long suffered from having seals formed along a bottom of the bag. These seals, whether formed using an adhesive or using a welded seal, have suffered from decreased strength associated with having the seal extend along the bottom of the bag. That is, when an item is placed in the bag, the bottom of the bag typically supports the weight of the item within the bag. With a seal formed at this location, the bag is weakened. Moreover, if the bottom seal does fail, there is an increased risk that the item contained within the bag will fall out of the bag as the bag is typically held in an upright position.

Conventional pinch bottom bags have been known to include a variety of folds, which are used to either strengthen the bottom of the bag or increase the holding capacity of the bags. For example, the bags shown in U.S. Patent Publication 2004/0066982 illustrate a horizontal bag that includes three layers formed from a single sheet and having a W-shaped fold; the top-most layer is folded back towards the bottom fold of the bag to form a handle. However, these conventional bottom folded bags, suffer from an increased marginal cost due to the increased material required to form the handle and the W-shaped fold.

Accordingly, there remains a need for improved systems, devices, and methods of forming pinch bottom bags.

### SUMMARY

In some aspects, a bag having a top and bottom is provided. The bags can include a first layer and a second layer opposite the first layer and uniformly extending from the first layer. In some aspects, the bag can further include a first side seam between a side of the first layer and an opposing side of the second layer and a second side seam between a side of the second layer and an opposing side of the second layer. The bags include a bottom fold extending along a transverse axis relative to the first side seam and the second side seam, the bottom fold forming a seamless bottom. The first layer and the second layer each have an un-folded edge that is substantially parallel to the bottom fold.

A method of forming bags having a seamless bottom is provided. In some aspects, the method can include receiving a sheet of bag material from a roll, folding the sheet of bag material to form a first layer, second layer, and seamless bottom, the first layer and the second layer each have an un-folded edge that is substantially parallel to the seamless bottom, and adhering the sheet of bag material in predetermined locations to form a plurality of side seams between the first layer and second layer.

A method of forming bags having a seamless bottom is provided. In some aspects, the method can include receiving a sheet of bag material from a roll, folding the sheet of bag material to form a first layer, second layer, and seamless bottom, and adhering the sheet of bag material in predetermined locations to form a plurality of side seams between the first layer and second layer by applying an adhesive to the sheet of bag material. The seamless bottom has a V-shaped, W-shaped, or other suitably shaped fold.

The above described and other features are exemplified by the accompanying drawings and detailed description.

### BRIEF DESCRIPTION OF THE DRAWINGS

This disclosure will be more fully understood from the following detailed description taken in conjunction with the accompanying drawings, in which:

FIG. 1 is a schematic view of a bag having a top and V-shaped bottom;

FIG. 2 is a schematic view of the starting position for forming the bag shown in FIG. 1;

FIG. 3 is a schematic view of the bag shown in FIG. 1 during formation thereof;

FIG. 4 is a schematic view of an exemplary system for forming a plurality of bags having V-shaped bottoms;

FIG. 5 is a schematic view of an exemplary system for forming a plurality of bags having V-shaped bottoms; and

FIG. 6 is a schematic view of an exemplary system for forming a plurality of bags having V-shaped bottoms.

### DETAILED DESCRIPTION

Certain exemplary aspects will now be described to provide an overall understanding of the principles of the structure, function, manufacture, and use of the devices, systems, methods, and/or kits disclosed herein. One or more examples of these aspects are illustrated in the accompanying drawings. Those skilled in the art will understand that the devices, systems, methods, and/or kits disclosed herein and illustrated in the accompanying drawings are non-limiting and exemplary in nature and that the scope of the present invention is defined solely by the claims. The features illustrated or described in connection with any one aspect described may be combined with the features of other aspects. Such modification and variations are intended to be included within the scope of the present disclosure.

Further in the present disclosure, like-numbered components generally have similar features, and thus each feature of each like-numbered component is not necessarily fully elaborated upon. Additionally, to the extent that linear or circular dimensions are used in the description of the disclosed systems, devices, and methods, such dimensions are not intended to limit the types of shapes that can be used in conjunction with such systems, devices, and methods. A person skilled in the art will recognize that an equivalent to such linear and circular dimensions can be determined for any geometric shape. Sizes and shapes of the systems and devices, and the components thereof, can depend at least on the size and shape of the components with which the systems and devices will be used, and the methods and procedures in which the systems and devices will be used.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

As used herein, the articles “a” and “an” preceding an element or component are intended to be nonrestrictive regarding the number of instances (i.e. occurrences) of the element or component. Therefore, “a” or “an” should be read to include one or at least one, and the singular word form of the element or component also includes the plural unless the number is obviously meant to be singular.

As used herein, the term “about” modifying the quantity of an ingredient, component, or reactant of the disclosure employed refers to variation in the numerical quantity that can occur, for example, through typical measuring and liquid handling procedures used for making concentrates or solutions. Furthermore, variation can occur from inadvertent error in measuring procedures, differences in the manufacture, source, or purity of the ingredients employed to make the compositions or carry out the methods, and the like. In one aspect, the term “about” means within 10% of the reported numerical value. In another aspect, the term “about” means within 5% of the reported numerical value. Yet, in another aspect, the term “about” means within 10, 9, 8, 7, 6, 5, 4, 3, 2, or 1% of the reported numerical value.

As mentioned above, conventional pinch bottom bags typically have bottom seals. These seals suffer from decreased strength. Folds along the bottom of bags have also been used to expand the capacity of bags. However, additional folds in the bottom of the bag may lead to unnecessary material costs. Further, bags that are formed from more than two layers of materials may also be costly. As such, bags formed by folding a single sheet of material once to form two layers and a seamless bottom fold are disclosed herein. These bags having a seamless bottom fold—without an adhesive seal in the portion of the bottom between the side seals (or side seams)—exhibit increased strength relative to bags with a bottom seal and may be cheaper to produce than other bottom folded bags. In other aspects, the bags have a seamless bottom fold, with both sides (faces) of the bag being formed of a continuous single sheet of material. The first side (face) and the second side (face) of the bag may include a bottom folded edge and three unfolded side edges. Optionally, the bag may include gussets along sides of the bag and/or as part of the seamless bottom of the bag.

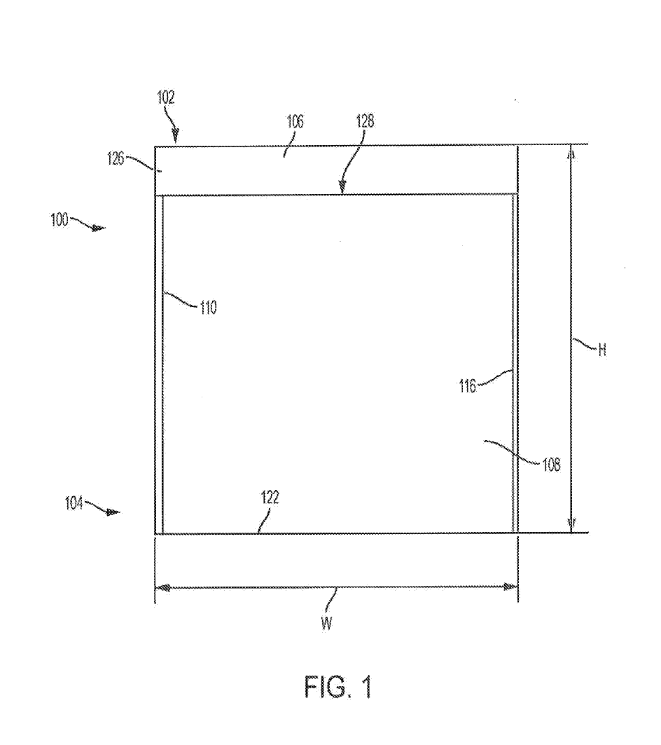

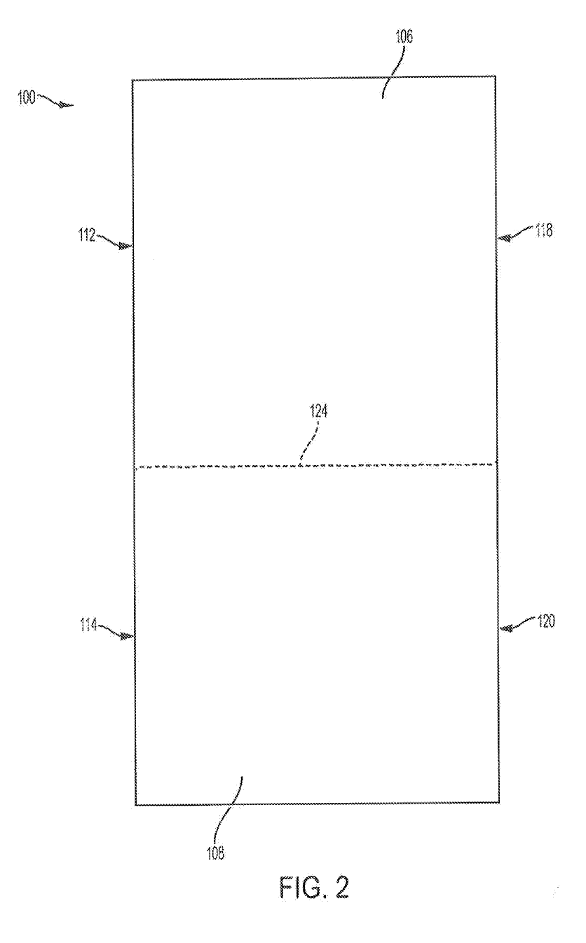

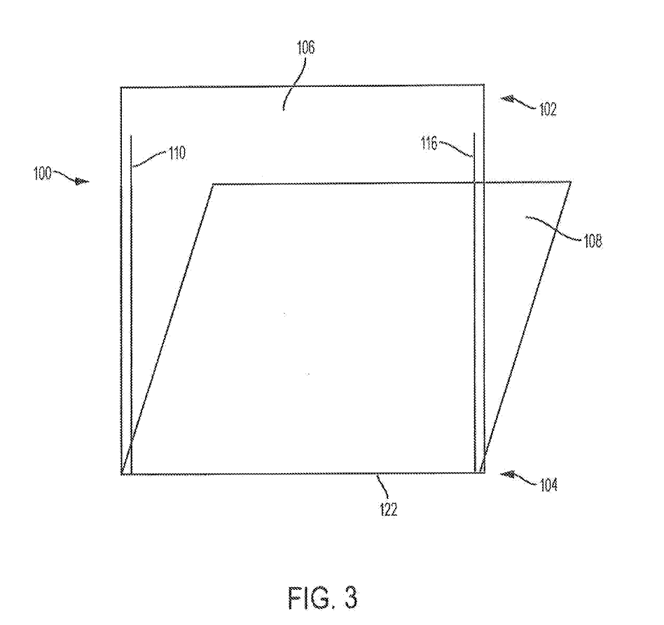

Turning now to the figures, FIG. 1 is a schematic view of a bag 100 having a top 102 and V-shaped bottom 104 according some embodiments. FIG. 2 is a schematic view of the starting position for forming the bag 100 shown in FIG. 1. FIG. 3 is a schematic view of the bag 100 shown in FIG. 1 during formation thereof. As shown in FIGS. 1-3, in some aspects, the bag 100 includes a first layer 106 and a second layer 108 opposite the first layer 106 and uniformly extending from the first layer 106. The top (uppermost) edge of the second layer 108 formed at the opening 128 is formed by the edge of the bag material (i.e., the top (uppermost) edge is not folded). The bag 100 can include a first side seam 110 formed by adhering a first side 112 of the first layer 106 to an opposing side 114 of the second layer 108 and a second side seam 116 formed by adhering a second side 118 of the first layer 106 to an opposing side 120 of the second layer 108. By forming the first and second seams 106, 108, as described, a bottom V-shaped fold 122 extending along a transverse axis 124 relative to the first side seam 110 and the second side seam 116 is formed. The bottom V-shaped fold 122 can form the seamless bottom 104. The first layer 106 and the second layer 108 each have an un-folded edge that is substantially parallel to the bottom fold. As used herein “seamless bottom” means that the bottom of the bag is formed of a uniform sheet of material with a fold, i.e., two separate sheets are not adhered along the bottom of the bag but may be adhered along peripheral edges. The seamless bottom can include a V-shaped bottom (as shown in FIG. 1), W-shaped bottom, or any other fold/shape.

The bag 100 can be formed with a variety of formations, materials, and methods. In some aspects, the top 102 of the bag 100 can be formed such that it has a tab portion 126 to make handling the bag easier, such as to allow easy insertion of food or other products into an opening 128 of the bag 100. For example, the first layer 106 can extend beyond the second layer 108 to form the tab portion 126. Alternatively, the second layer 106 can extend beyond the first layer 106 to form a tab portion. Moreover, the top 102 of the bag 100 can include a variety of top features, including but not limited to a handle or handles, seals—such as an adhesive seal (e.g., a peel-and-stick seal) or zip-lock seal, decorative features, and/or any other suitable surface feature.

The first and second layers 106, 108 may be formed of any suitable material. For example, the first layer 106 and second layer 108 can be formed of any suitable pliable material, including low or high density polypropylene, thermoplastic, fabric, nylon, paper, or laminated paper. For example, in some aspects, the first and second layers 106, 108 are formed of paper. Additionally, the first and second layers 106, 108 can be formed from a single sheet of material. The single sheet of material forming the first and second layers 106, 108 can include multiple layers. In one example, a multi-ply sheet of material can be folded to form first and second layers 106, 108. In other words, first layer 106 and second layer 108 can each be a single ply sheet or a multi-ply sheet (i.e., including more than two layers). For example, as shown in FIGS. 1-3, a single sheet of pliable material is folded approximately in half to form the first layer 106 and second layer 108. This fold creates the bottom V-shaped fold 122 extending along the transverse axis 124 relative to the first side seam 110 and the second side seam 116. This fold forms a strengthened bottom 104 of the bag 100 as compared to other methods of forming a bag bottom, such as adhering two separate sheets at a bottom of a bag. Although a V-shaped fold 122 is shown, the bag may include any other shaped fold or gussets along the bottom or sides, provided that the material is folded approximately in half, for example as shown in FIG. 1, to form the first layer 106 and second layer 108.

As used herein, folding “approximately in half,” means that the sheet of material may be folded substantially exactly in half (not shown in the Figures) or slightly off-center (i.e., offset less than about 25% of the height H, as shown in FIG. 1, of the bag) such that a tab 126 is formed at the top 102 of the bag 100 (as shown in the example of FIG. 1). In the case of a V-shaped fold, for example, the bottom vertex of the V-shaped fold should be used for the measurement. In the case of a bottom W-shaped fold, for example, the middle fold of the W-fold should be used for the measurement. For clarity, slightly off-center (i.e., offset less than 25% of height H) is intended to encompass all values greater than zero and less than about 25% including for instance 0.1%, 1%, 2%, 3%, 4%, 5%, 10%, 15%, 20%, 25%, as well as all ranges therebetween such as 0.1-25%, 0.1-24%, 1-25%, 1-24%, 2-23%, 5-15%, and all iterations of values therebetween.

The bag 100 can have any suitable dimensions. In some aspects, the bag 100 can be configured, formed, or dimensioned so as to hold any desirable component—including hardware parts, food products, retail merchandise, prescriptions, or any other product typically stored, carried, or presented in bags. In some aspects, the bag 100 can be used for food product packaging, storage, or transport. For example, the bag 100 can be dimensioned to hold a cookie, soft pretzel, French fries, and/or pastry. In some aspects, the bag can have a height H of between about 2 inches (in) and 24 inches (in). In some aspects, the bag can have a height H of between about 6 inches (in) and 10 inches (in). In some aspects, the bag 100 can have a width W of between about 2 inches (in) and 12 inches (in). In some aspects, the bag 100 can have a width W of between about 5 inches (in) and 7 inches (in).

“Adhering” as used herein can be accomplished by a variety of methods including applying an adhesive, creating a sideweld, heat seal, sewn seal, or any other suitable sealing method, if an adhesive is applied, any suitable adhesive can be used and in some aspects the adhesive can be a food-safe adhesive. In some aspects, for example, the adhesive—if one is used—can be an adhesive that is compliant with one or more Food and Drug Administration (FDA) regulations and/or guidelines for food-based adhesives, such as but not limited to Title 21 of the U.S. Code of Federal Regulations (CFR) sections 175.105 Indirect food additives, 175.125 Pressure sensitive adhesives, 176.170 Components of paper and paperboard in contact with aqueous and fatty foods, 176.180 Components of paper and paperboard in contact with dry foods, 16 CFR 1500.3(C)(4) for direct skin contact—adhesives for direct use with skin, and/or 16 CFR 1500.3(C)(2)(i) for oral toxicity—non-toxic adhesives. Exemplary adhesives include starch-based adhesives such as dextrin, casein-based adhesives, silicone adhesives, waxes, polyester resins, polyols, polyurethanes, polyvinyl chloride adhesives, acrylic polymers, elastomers, thermoplastics, emulsions, thermosets, hot melts, and/or any other suitable adhesive.

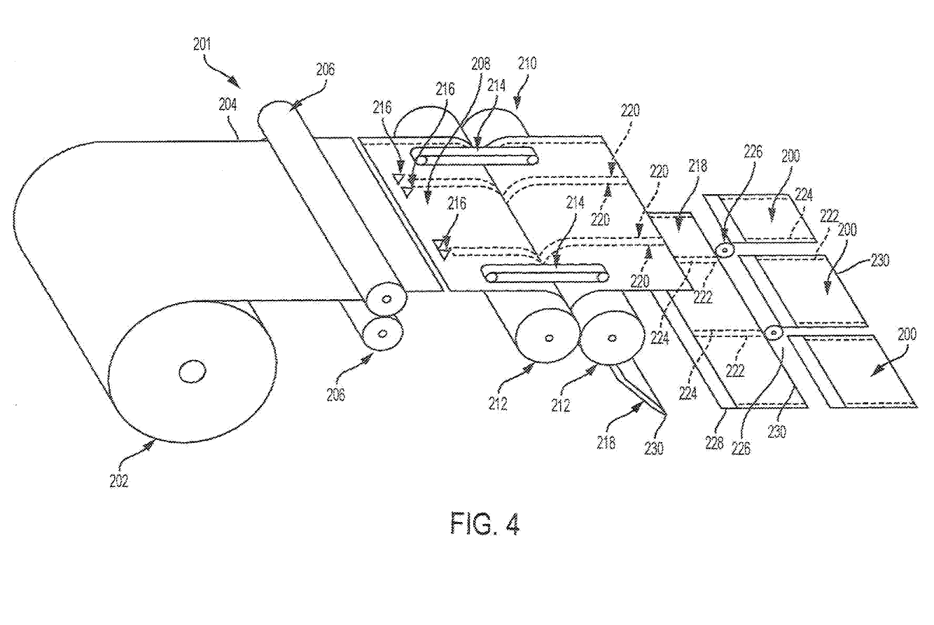

Forming the bag 100 can be accomplished using any suitable method. In some aspects, machinery can be configured to form a plurality of bags 100 simultaneously and/or rapidly. Exemplary systems are described below, such as those shown in FIGS. 4-6.

FIG. 4 is a schematic view of an exemplary system 201 for forming a plurality of bags 200 having V-shaped bottoms. As shown, a roll 202 of sheet material 204 is provided. The sheet material 204 is then fed through a knife and anvil roller 206. In one aspect, the knife and anvil roller 206 is configured to cut the sheet material 204 along an axis that is transverse to the feed direction of the sheet material 204 (i.e., along a longitudinal axis of the roll 202). After cutting the sheet material 204, the cut sheet 208 can be fed to a folding station 210.

The folding station 210, in some aspects, can comprise a folding mechanism such as folding rollers 212, a sheet positioning mechanism such as guide belts 214, and a side seal forming mechanism such as glue nozzles 216. As shown, the folding station 210 receives the cut sheet 208 and outputs folded sheet 218 having a plurality of bags 200 formed thereon. In some aspects, such as that shown in FIG. 4, the folded sheet 218 can have a plurality of bags 200 formed along the transverse axis of the sheet material 202. To achieve said configuration, the folding station 210—in at least some aspects—can receive the cut sheet 208 into the folding station 210 and position the cut sheet 208 above the folding rollers 212. To properly position the cut sheet 208 above the folding rollers 212, the guide belts 214 can pull and/or push the cut sheet after being received from the knife and anvil roller 206—i.e., translate the cut sheet along the feed direction of the sheet material. In aspects that utilize an adhesive to seal the side seams of the bags 200, the folding station 210 can also include adhesive nozzles 216. One of ordinary skill in the art will appreciate, however, that said adhesive nozzles 216 are optional and other side seam sealing devices and or methods may be utilized with the system 201, such as suitable welding devices. If used, however, the adhesive nozzles 216 can be positioned above the cut sheet 208 so as to apply an adhesive 220 such that the adhesive will seal the edges of the plurality of bags 200. In some non-limiting aspects such as is shown in FIG. 4, two strips of adhesive 220 can be applied adjacent to one another such that the bags can be separated between the adjacent adhesive 220 strips to form side seam seals 222, 224.

As described, the folding station 210 can include a folding mechanism such as folding rollers 212. The folding mechanism is not limited to folding rollers 212 but can be any suitable folding mechanism sufficient to produce a seamless bottom fold. Although a V-shaped fold is shown, the bag may include any other shaped fold or gussets, provided that the material is folded approximately in half (for example, as shown in FIG. 1) to form the first layer and second layer of the bag. The folding rollers 212, as shown, function by pinching a middle portion of the cut sheet 208 once the cut sheet 208 is appropriately positioned above the folding rollers 212 and then rolling the cut sheet 208 through the folding rollers 212 to fold the cut sheet 208 and press the adhesive 220 strips together to form the seams 222, 224. The folding rollers 212 can use mechanical grippers or vacuum assistance to fold the cut sheet 208. In the embodiment shown in FIG. 4, the folding rollers 212 pinch the cut sheet such that a tab portion 228 is formed in the bag 200. That is the bottom fold 230, i.e., the pinch point, is slightly off-center along the longitudinal axis of the cut sheet 208.

Furthermore, the system 201 can include a cutting mechanism 226 configured to separate the bags 200 between the adjacent adhesive 220 strips to form side seam seals 222, 224, as shown in FIG. 4. As shown, the cutting mechanism 226 is placed downstream of the folding station 210. A person of ordinary skill in the art, however, will appreciate that in some aspects the cutting mechanism 226 can be placed upstream of the folding station 210 or can be integrated within the folding station 210. Any suitable cutting mechanism 226 can be used, such as but not limited to a rotating blade, static blade, opposed rollers with cutting surfaces, anvil, laser, hot-knife, and/or any other suitable cutting and/or separating mechanism. For example, the cutting mechanism 226 could be an anvil (not shown) that is configured to perforate the folded cut sheet 208 between the bags 200 such that a down-stream user can separate the bags, either mechanically or by hand, along the perforations.

In addition to depositing adjacent adhesive 220 strips and subsequently cutting between the adjacent strips to form individual bags, as shown in FIG. 4, a single adhesive strip may be deposited, followed by cutting to split the single adhesive strip between two bags (not shown).

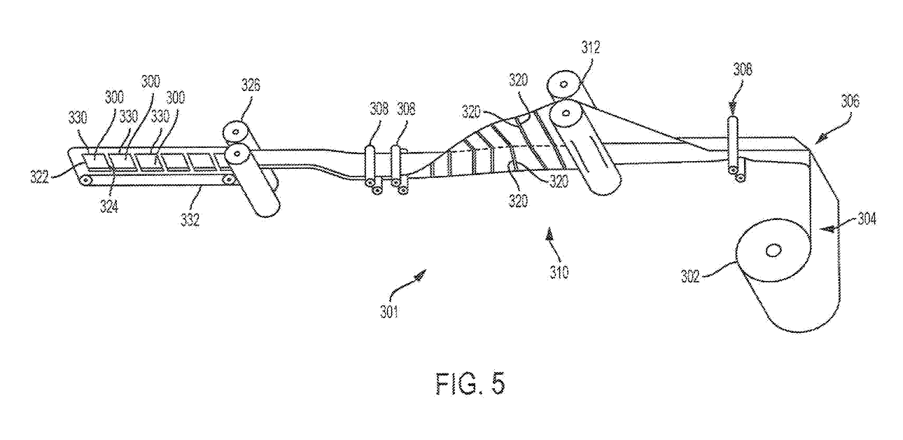

FIG. 5 is a schematic view of an exemplary system 301 for forming a plurality of bags 300 having V-shaped bottoms. As shown, a roll 302 of sheet material 304 is provided. The sheet material 304 is then fed through a folding station 310. As shown, the folding station 310 can include a variety of folding apparatuses such as a plow folder 306, fold presses 308, and side seam forming mechanism such as a glue applicator 312. As shown, the sheet material 304 can be fed from the roll 302 to the plow folder 306 and the fold press 308 to fold the sheet material in approximately in half along a longitudinal axis of the sheet material 304. After the sheet material 304 leaves the plow folder 306, it is folded to form a pattern for individual single bags 300 that are subsequently cut. Although only one plow folder 306 is shown, an additional plow folder 306 may be included to add an additional fold in the sheet material 304 (for example, that folds the sheet material 304 in the opposite direction of the first fold) to form a pattern for two bags 300 across the width of the sheet material 304. A person of ordinary skill in the art will appreciate that any suitable in-line folding device can be used to make folds in the direction of the web, or sheet material, travel. This fold in the direction of travel, once processing is completed, will form the V-shaped bottom 330 of the bags 300. Exemplary folders include a plow folder, former folder, jaw folder, and/or a chopper folder. In some aspects, the movability of plow heads allows for greater flexibility than a former folder in the number and width of folds which can be made in the sheet material. In some aspects, a former fold can create a single fold made parallel to the direction of sheet material travel, created as the sheet material is pulled over a triangular metal former board. The former fold is usually the first fold made, and, depending on the application, a former fold may be the only fold required. As will be appreciated by one of ordinary skill, a former fold is also called a newspaper fold or a plow fold. As described, any folding mechanism suitable to form a V-shaped bottom can be used.

The folding station 310, as shown in FIG. 5, can include a fold press 308, or as shown, a plurality of fold presses 308. In some aspects, the fold presses 308 are configured to press the folded sheet material to form the fold, either as the fold is made in the plow fold 306 or after passing through a side seam forming mechanism 312. In some aspects, the fold presses 308 include two rollers that are opposed from one another and configured to press the folded sheet material 304 between the opposed rollers.

The folding station 310 can include a side seam forming mechanism 312. In some aspects, the side seam forming mechanism is an adhesive applicator. For example, roller-type adhesive applicator can be used to apply adhesive strips 320 at predetermined intervals along an axis that is transverse to the sheet material (i.e., perpendicular to the direction of travel). In some aspects, the side seam forming mechanism 312 can include a hot melt adhesive applicator, an adhesive spraying nozzle, a welding apparatus such as a heated anvil, and/or any other suitable seam forming device. In some non-limiting aspects such as is shown in FIG. 5, two strips of adhesive 320 can be applied adjacent to one another such that the bags can be separated between the adjacent adhesive 320 strips to form side seam seals 322, 324.

If an adhesive is used, following application of the adhesive strips, a folding press 308 can be used to press the adhesive strips together to form the side seams for the bags 300. Furthermore, the system 301 can include a cutting mechanism 326 configured to separate the bags 300 between the adjacent adhesive 320 strips to form side seam seals 322, 324. As shown, the cutting mechanism 326 is placed downstream of the folding station 310. A person of ordinary skill in the art, however, will appreciate that in some aspects the cutting mechanism can be placed upstream of the folding station 310 or can be integrated within the folding station 310. Any suitable cutting mechanism 326 can be used, such as but not limited to a rotating blade, static blade, opposed rollers with cutting surfaces, anvil, laser, hot-knife, and/or any other suitable cutting and/or separating mechanism. For example, the cutting mechanism 326 could be an anvil (not shown) that is configured to perforate the folded sheet between the bags 300 such that a down-stream user can separate the bags, either mechanically or by hand, along the perforations.

The system 301 can include any number of additional processing steps and/or equipment to facilitate transport and processing of the bags 300. For example, as shown in FIG. 5, the system 301 can include a conveyor 332 to transport the formed bags 300 downstream for further processing, such as printing and/or packaging.

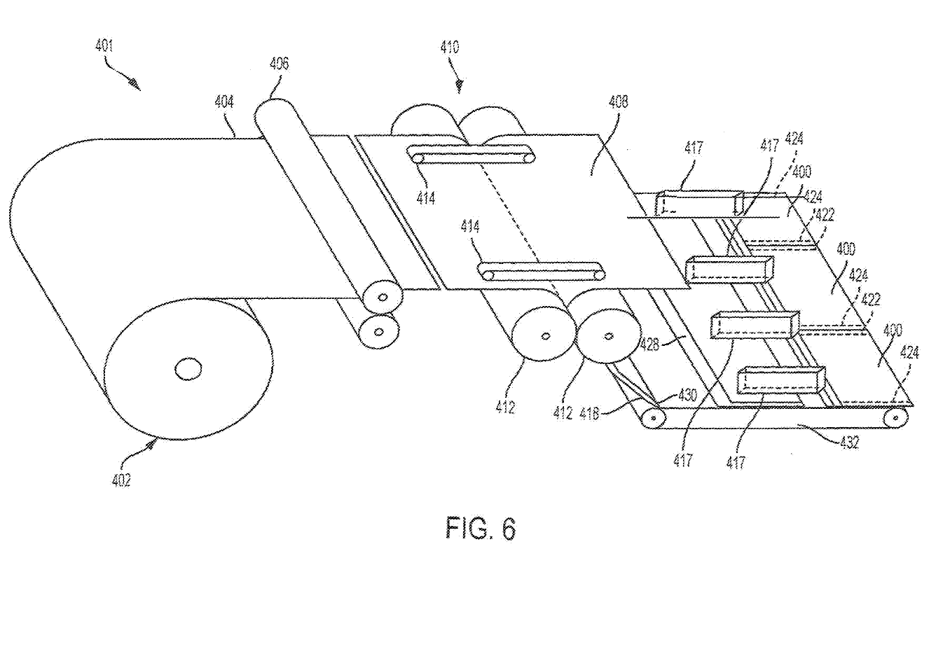

FIG. 6 is a schematic view of an exemplary system 401 for forming a plurality of bags 400 having V-shaped bottoms. As shown, a roll 402 of sheet material 404 is provided. The sheet material 404 is then fed through a knife and anvil roller 406. In one aspect, the knife and anvil roller 406 is configured to cut the sheet material 404 along an axis that is transverse to the feed direction of the sheet material 404 (i.e., along a longitudinal axis of the roll 402). After cutting the sheet material 404, the cut sheet 408 can be fed to a folding station 410.

The folding station 410, in some aspects, can comprise a folding mechanism such as folding rollers 412, a sheet positioning mechanism such as guide belts 414, and a side seal forming mechanism 417. As shown, the folding station 410 receives the cut sheet 408 and outputs folded sheet 418 having a plurality of bags 400 formed thereon. In some aspects, the folded sheet 418 can have a plurality of bags 400 formed along the transverse axis of the sheet material 402. To achieve said configuration, the folding station 410—in at least some aspects—can receive the cut sheet 408 into the folding station 410 and position the cut sheet 408 above the folding rollers 412. To properly position the cut sheet 408 above the folding rollers 412, the guide belts 414 can pull and/or push the cut sheet after being received from the knife and anvil roller 406—i.e., translate the cut sheet along the feed direction of the sheet material.

As described, the folding station 410 can include a folding mechanism such as folding rollers 412. The folding mechanism is not limited to folding rollers 412 but can be any suitable folding mechanism sufficient to produce a seamless bottom fold, for example, a V-shaped bottom fold. The folding rollers 412, as shown, function by pinching a middle portion of the cut sheet 408 once the cut sheet 408 is appropriately positioned above the folding rollers 412 and then rolling the cut sheet 408 through the folding rollers 412 to fold the cut sheet 408. The folding rollers 412 can use mechanical grippers or vacuum assistance to fold the cut sheet 408. In the embodiment shown in FIG. 6, the folding rollers 412 pinch the cut sheet such that a tab portion 428 is formed in the bag 400. That is the bottom fold 430, i.e., the pinch point, is slightly off-center along the longitudinal axis of the cut sheet 408.

As shown in FIG. 6, side sealers 417 may be utilized with the system 401 to form side seams 422, 424 on the bags 400. That is, the side sealers 417 can be configured for adhering the sheet of bag material to form a sideweld seal, heat seal, other suitable seal. As shown in FIG. 6, the side sealers 417 are positioned downstream of the folding rollers 412 such that the side sealers 417 receive the folded sheet 418. Once positioned beneath the side sealers 417, the folded sheet 418 is stamped with or passed under the side sealer 417 such that a first layer and second layer of the folded sheet are welded, fused, or otherwise combined together using pressure and/or adhesive to form a seal. In some non-limiting aspects such as is shown in FIG. 6, the side sealers 417 can be configured to form seams that are adjacent to one another such that the bags 400 can be separated between the adjacent seams to form side seam seals 422, 424. In some aspects the side sealers 417 can be configured to simultaneously seal the seams 422, 424 of the bags 400 and to separate the bags 400 from one another. Alternatively, the bags 400 can be separated from one another in a separate process. The side sealers 417 can be any suitable welder, such as a heated anvil type welder, ultrasonic vibration welder, or any other suitable welder. Alternatively, the side sealers 417 can be or further include a sewing head (not shown) so as to form a sewn seal. The system 401 can include any number of additional processing steps and/or equipment to facilitate transport and processing of the bags 400. For example, as shown in FIG. 6, the system 401 can include a conveyor 432 to transport the formed bags 400 downstream for further processing, such as printing and/or packaging. As shown, the side sealers 417 can optionally be positioned above the conveyor 432. Moreover, the side sealers 417 can include a portion of the side sealer beneath the folded sheet 418.

In the systems described herein, such as those shown in FIGS. 4-6, the system components can optionally be passive or driven. For example, the folding rollers 212, 412 or adhesive applicator 312 can be driven by a motor (not shown) such as a servo motor, in order to translate the sheet material through the system. Any such system component, either shown or not, can be driven or powered so as to translate the sheet material through the system as is needed.

With respect to the above description, it is to be realized that the optimum composition for the parts of the invention, to include variations in components, materials, size, shape, form, function, and manner of operation, assembly and use, are deemed readily apparent to one skilled in the art, and all equivalent relationships to those illustrated in the examples and described in the specification are intended to be encompassed by the present invention. Therefore, the foregoing is considered as illustrative only of the principles of the invention. Further, various modifications may be made of the invention without departing from the scope thereof, and it is desired, therefore, that only such limitations shall be placed thereon as are set forth in the appended claims. Those skilled in the art will appreciate that terms such as “top” and “bottom” and “first” and “second” are useful in describing the bags and systems described herein, but essentially depend on the orientation of such bag or system when such terms are used and are therefore not limiting to any particular orientation unless expressly stated otherwise.

What is claimed is:

1. A bag having a top and bottom, comprising:
a first layer;
a second layer opposite the first layer and uniformly extending from the first layer;
a first side seam between a side of the first layer and an opposing side of the second layer;
a second side seam between a side of the second layer and an opposing side of the second layer; and
a bottom fold extending along a transverse axis relative to the first side seam and the second side seam, the bottom fold forming a seamless bottom;
wherein the first layer and the second layer each have an un-folded edge that is substantially parallel to the bottom fold.

2. The bag of claim 1, wherein the bottom fold is a V-shaped fold.

3. The bag of claim 1, wherein the first layer extends beyond the second layer to form a tab portion.

4. The bag of claim 1, wherein the first and second layers are formed of paper.

5. The bag of claim 1, wherein the first and second layers are formed of at least one of a low density polyethylene, high density polyethylene, thermoplastic, fabric, nylon, or paper.

6. The bag of claim 1, wherein the first and second side seams are formed by adhering the first layer to the second layer by applying an adhesive between the first and second layers.

7. The bag of claim 1, wherein the first and second side seams are formed by adhering the first layer to the second layer using any of a sideweld, heat seal, or sewn seal.

8. A method of forming bags having a seamless bottom, comprising:
receiving a sheet of bag material from a roll;
folding the sheet of bag material to form a first layer, second layer, and seamless bottom, the first layer and the second layer each have an un-folded edge that is substantially parallel to the seamless bottom; and
adhering the sheet of bag material in predetermined locations to form a plurality of side seams between the first layer and second layer.

9. The method of claim 8, wherein:
folding the sheet of bag material comprises folding the sheet of bag material along a longitudinal axis of the sheet of bag material.

10. The method of claim 8, wherein adhering the sheet of bag material comprises applying an adhesive to the sheet of bag material.

11. The method of claim 9, wherein the adhesive is a food-safe adhesive.

12. The method of claim 8, wherein adhering the sheet of bag material comprises forming a sideweld, heat seal, or sewn seal.

13. The method of claim 9, wherein folding the sheet of bag material comprises using a plow fold to form a V-shaped bottom.

14. The method of claim 8, further comprising:
prior to folding the sheet of bag material, cutting the sheet of bag material along a transverse axis at predetermined lengths such that each length of bag material is sufficient to form a first bag layer and a second bag layer when folded along an axis that is transverse to the sheet.

15. The method of claim 8, wherein folding the sheet of bag material comprises folding the sheet of bag material along an axis that is transverse to the sheet such that a V-shaped bottom is formed.

16. The method of claim 8, wherein folding the sheet of bag material comprises using opposing folding rollers to form the bottom of the bag with a V-shaped bottom by pulling the sheet material through the opposing folding rollers.

17. The method of claim 8, wherein the sheet of bag material is formed of paper.

18. The method of claim 8, wherein the sheet of bag material is formed of at least one of low density polyethylene, high density polyethylene, thermoplastic, fabric, nylon, or paper.

19. The method of claim 8, further comprising cutting the folded and adhered sheet material between adjacent side seams to form a plurality of bags.

20. A method of forming bags having a seamless bottom, comprising:
receiving a sheet of bag material from a roll;
folding the sheet of bag material to form a first layer, second layer, and seamless bottom; and
adhering the sheet of bag material in predetermined locations to form a plurality of side seams between the first layer and second layer by applying an adhesive to the sheet of bag material;
wherein the seamless bottom has a V-shaped fold.

21. The method of claim 20, wherein the adhesive is a food-safe adhesive.

22. The method of claim 20, further comprising cutting the folded and adhered sheet material between adjacent side seams to form a plurality of bags.
